(19) United States
(12) Patent Application Publication
(10) Pub. No.: US 2006/0048615 A1
(43) Pub. Date: Mar. 9, 2006

(54) Multi-radial shaft for releasable shaft holders

(76) Inventor: Peter J. Treige, Platteville, WI (US)

Correspondence Address: JOHN V STEWART, 1308 HENRY BALCH DRIVE, ORLANDO, FL, 32810, US

(21) Appl. No.: 10/935,840

(22) Filed: Sep. 8, 2004

(51) Int. Cl. B23B 29/00

(52) U.S. Cl. 82/158

(57) ABSTRACT

A shaft for clamping in the bore of a releasable holder. On a transverse section plane, the circumference of the shaft is a series of arcs with different centers. These arcs intersect in sequence at their end points. Each intersection forms a slight ridge along the length of the shaft. Two of the ridges flank the point opposite the clamping element. These two ridges contact the bore, and they lie at the distance from the axis of the tool equal to the radius of the bore of the holder. Thus, they precisely locate the center of the shaft at the center of the bore. Two additional ridges on the shaft flank the clamping element. These additional ridges clear the holder bore just enough so that when the clamping element is released, the shaft can readily slide out of the bore and also can be easily re-inserted.

### BACKGROUND OF THE INVENTION

1. Field of the Invention

This invention relates to tool shafts that are used in releasable holders, especially shanks for rotary tools such as machining cutters and drills and in stationary tools such as boring bars in lathes.

2. Description of Prior Art

Shafts of rotary tools are commonly cylindrical. A cylindrical shape can be held in a variety of holder types. However, in one of the most commonly used holders, called an end mill holder, there is a drawback to using a cylindrical shaft. This type of holder has a bore into which a tool shaft is slidably inserted. It is fixed in the holder by a clamping element. This is typically a setscrew that threads through the side of the holder and bears laterally against the shaft to pin it in place. The clamping element presses against the cylindrical surface of the shaft or against a flat portion on its surface. The shaft must be smaller in diameter than the holder bore so that the shaft can be readily inserted or removed by hand.

The prior art views of FIGS. 1-3 show an undesirable condition that necessarily occurs when a cylindrical shaft 23 is fitted into a holder 20 whose bore 21 has a diameter larger than that of the shaft. The shaft makes contact with the bore at a single point 25 opposite the clamping element, which longitudinally forms a single line of contact where the smaller radius 28 of the shaft rests against the larger radius 30 of the bore. This line of contact and the clamping element or elements 22 on the opposite side constitutes the entire holding interface, which limits the holding arrangement to two-sided gripping. With the exception of these two contact areas, a gap 26 of varying width exists all around the sides of the shaft. This gap provides a space into which the shaft can deflect when lateral force is applied to the tool. This freedom of movement weakens the rigidity of the shaft/holder connection, lessens the precision of alignment of the shaft, and allows vibration to occur. These effects all negatively impact the performance of the tool element supported by the shaft.

A common method used to reduce this effect is to minimize the clearance. However, when the clearance is reduced below a certain point the shaft cannot easily be assembled into the bore by hand. Another problem with this strategy is the fact that manufacturers need practical tolerances for production of both holders and of tool shafts. Industry standards require that for a given nominal diameter, the largest diameter shaft within the tolerances will assemble with the smallest diameter holder bore. However, this means that the smallest allowable shaft will be comparatively loose when assembled with the largest allowable holder bore.

FIG. 3 illustrates another problem with fitting a cylindrical shaft 24 into a bore 21 with a larger diameter than that of the shaft. When a clamping force 19 is applied laterally to the shaft, pushing it into contact with the opposite side of the bore 25, the centerline of the shaft 27 is displaced from the centerline of the bore 29 by a distance 34 approximately equal to the difference between the radius 30 of the bore and the radius 28 of the shaft. A prior method that attempts to correct this well-known problem is to manufacture the bore of the holder off-center by an amount predicted to compensate for the out of concentric condition. However, this is imprecise because each radius is not precisely known due to tolerances and wear.

After extended use, the area 25 of the holder bore 21 opposite the clamping element 22 can become worn or deformed. This allows a cylindrical shaft to shift and vibrate even more readily under dynamic loads. This worn condition also causes the center line 27 of a shaft held in the bore to be even further displaced 34 from the bore center line 29.

Another solution to the above problems is to use a “shrink-fit holder” which has a bore very slightly smaller than the tool shaft it holds. The holder is heated, causing the bore to expand and allowing the shaft to be inserted, and then it cools and shrinks to securely grip and accurately center the shaft. Drawbacks of this system include high cost, both for the holders and for the heating system needed; heating and cooling processes slow the tool exchange process, and they can't be performed with the holder installed in the machine; Risk of burns to the operator.

U.S. Pat. No. 2,362,053 of Danielson provided a shaft with three points of contact in a bore, but it was only suitable for use in fixed bore type holder. It would not be dynamically stable or true in other types of holders such as segmented collets. Also, the Danielson shaft design had up to nineteen surfaces, making it difficult and expensive to produce.

### SUMMARY OF THE INVENTION

An object of the invention is provision of a tool shaft that overcomes the inherent weaknesses of conventional cylindrical shafts when held in an end mill type holder, and provides the following advantages:
1. More stable grip in the holder
2. Lower vibration under side loads while rotating (as in cutting)
3. More precise concentric location of the shaft in the holder
4. Better positional repeatability of tools using this shaft
5. Easier installation and removal of tools to and from holders
6. Uses of a portion of the holder bore that has little or no wear
7. Distributes the clamping forces on the holder, reducing distortion

Another object is improved performance and longevity of any tool carried by this shaft. Another object is practicality of production at minimal cost.

These objects are realized in a shaft for clamping in the bore of a holder. In cross section, the circumference of the shaft is a series of arcs with different centers. These arcs intersect in sequence at their end points. Each intersection forms a slight ridge along the length of the shaft. Two of the ridges flank the point opposite the clamping element. These two ridges contact the bore, and they lie at the distance from the axis of the tool equal to the radius of the bore of the holder. Thus, they precisely locate the center of the shaft at the center of the bore. Two additional ridges on the shaft flank the clamping element. These additional ridges clear the holder bore just enough so that when the clamping element is released, the shaft can readily slide out of the bore and also can be easily re-inserted.

### BRIEF DESCRIPTION OF THE DRAWINGS

FIG. 1 is a cross sectional view of a conventional cylindrical tool shaft locked into a holder with a setscrew. The shaft/bore clearance is exaggerated for clarity.

FIG. 2 is a cross sectional view of a conventional cylindrical tool shaft with a flat portion locked into a holder with a setscrew. The shaft/bore clearance is exaggerated for clarity.

FIG. 3 is a schematic cross sectional view of the conventional tool shaft of FIG. 1 in a holder bore. The shaft/bore clearance is exaggerated for clarity.

FIG. 4 is a side view of a rotary tool shaft with a working end partially shown.

FIG. 5 is a cross sectional view of a multi-radial tool shaft according to the invention locked into a holder with a setscrew. The arc center offsets and shaft/bore clearances are exaggerated for clarity.

FIG. 6 is a schematic cross sectional view of the multi-radial tool shaft of FIG. 5 with three surface arcs and a flat in a holder bore. The arc center offsets and shaft/bore clearances are exaggerated for clarity.

FIG. 7 is a schematic cross sectional view of a multi-radial tool shaft with four surface arcs in a holder bore. The arc center offsets and shaft/bore clearances are exaggerated for clarity.

FIG. 8 is a schematic cross sectional view of a multi-radial tool shaft drawn to relative scale with example dimensions for a holder bore with a nominal 1-inch diameter. The example bore has a slightly oversized radius of 0.5002 per normal practice.

FIG. 9 is a schematic cross sectional view of geometry of a multi-radial tool shaft in a six-way segmented collet. The collet and shaft are both shown in section, but the shaft is free of section lines in order to show the arc angles clearly. The shaft shape is not exaggerated here, so the clearances are small.

FIG. 10 is a schematic cross sectional view of geometry of a multi-radial tool shaft in an eight-way segmented collet. The collet and shaft are both shown in section, but the shaft is free of section lines in order to show the arc angles clearly. The shaft shape is not exaggerated here, so the clearances are small.

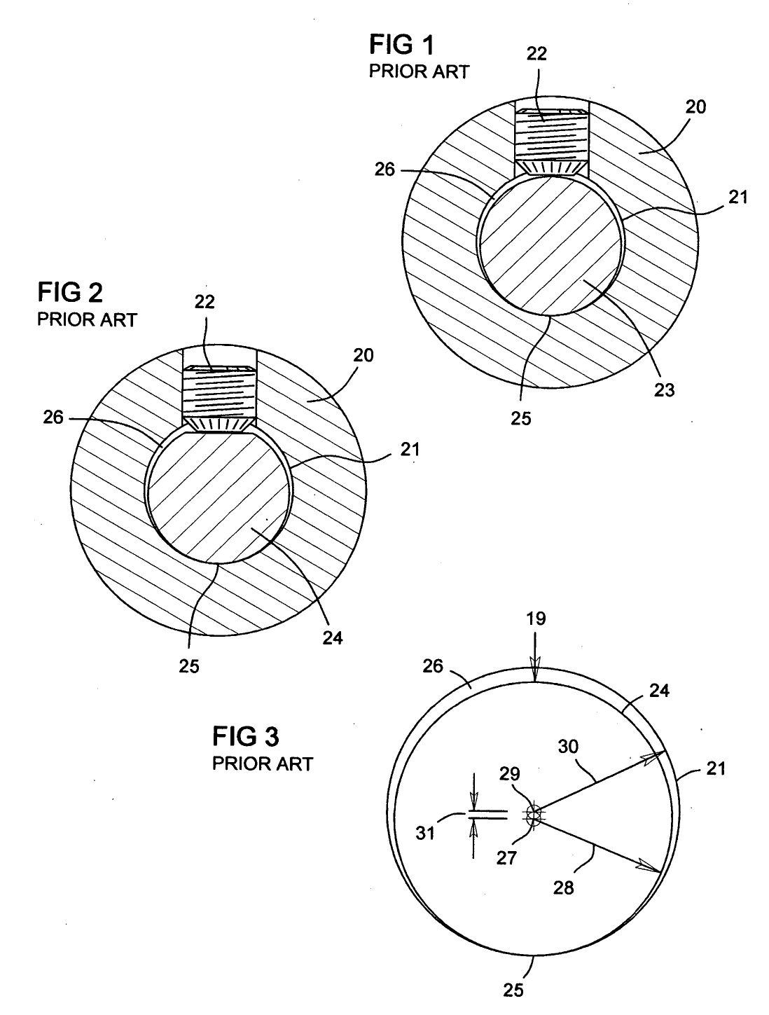

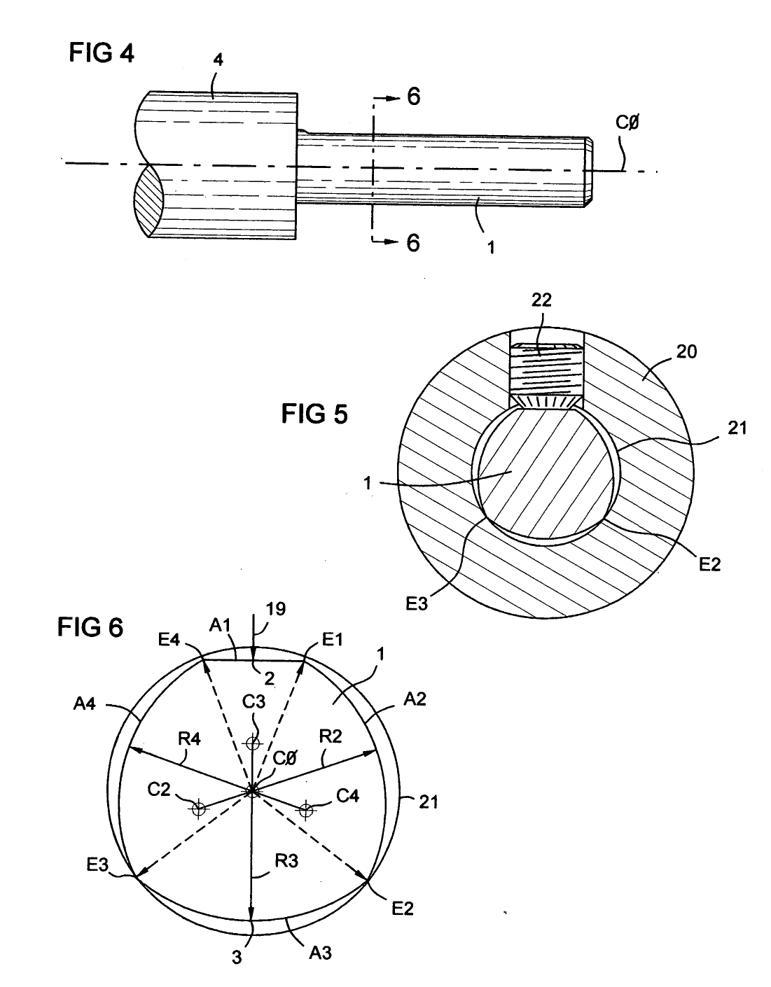

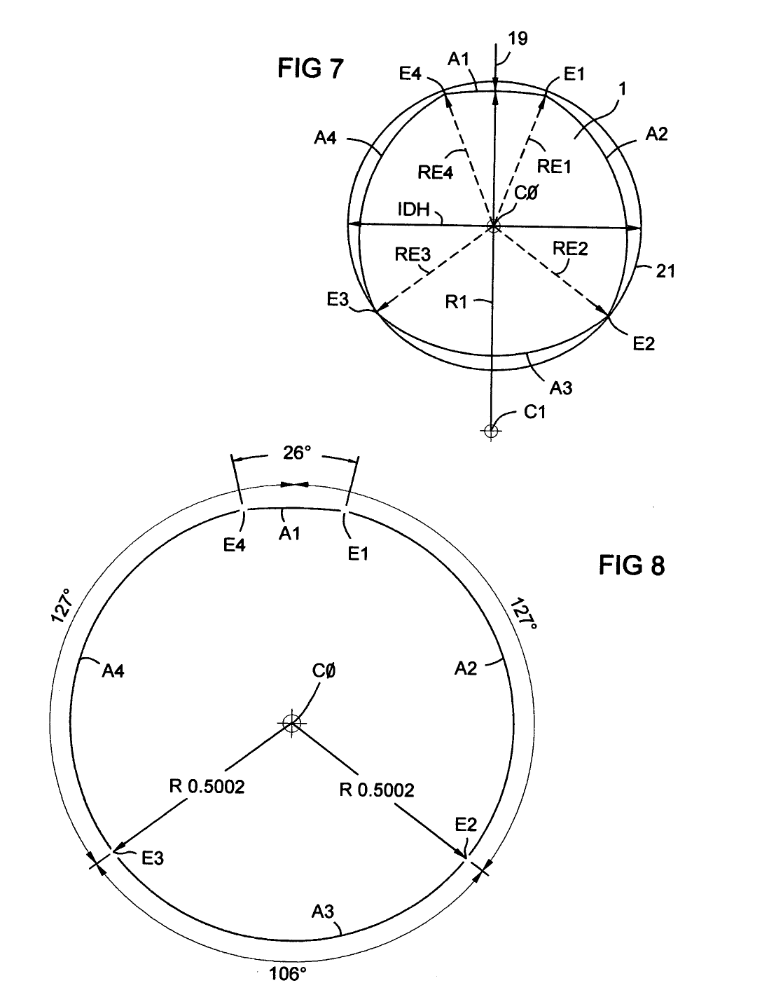

### REFERENCE NUMBERS

A1 Arc 1, which can optionally be flat
A2 Arc 2
A3 Arc 3
A4 Arc 4
C0 Tool shaft axis or centerline
C1 Center of arc 1
C2 Center of arc 2
C3 Center of arc 3
C4 Center of arc 4
E1 Meeting point of two arcs defining peak of ridge 1
E2 Meeting point of two arcs defining peak of ridge 2
E3 Meeting point of two arcs defining peak of ridge 3
E4 Meeting point of two arcs defining peak of ridge 4
IDH Actual diameter of a given holder bore
R1 Radius of arc 1
R2 Radius of arc 2
R3 Radius of arc 3
R4 Radius of arc 4
RE1 Radial distance of point E1 from centerline C0
RE2 Radial distance of point E2 from centerline C0
RE3 Radial distance of point E3 from centerline C0
RE4 Radial distance of point E4 from centerline C0
S1 Angular span of arc 1
1. Multi-radial shaft
2. Pressure point on shaft
3. Opposite point on shaft
4. Working part of rotary tool
19. Clamping force
20. Setscrew type tool shaft holder
21. Bore of setscrew type holder
22. Setscrew
23. Conventional cylindrical shaft
24. Conventional cylindrical shaft with flat portion
25. Point of contact between cylindrical shaft and bore opposite setscrew
26. Clearance between conventional cylindrical shaft and bore
27. Axis or centerline of cylindrical shaft
28. Radius of cylindrical shaft
29. Axis or centerline of holder
30. Radius of holder bore
31. Offset between holder axis and cylindrical shaft axis
40. Eight-way segmented collet type tool shaft holder
41. Six-way segmented collet type tool shaft holder

### DETAILED DESCRIPTION

The invention is a tool shaft 1 for use with a working end 4 of a rotary tool such as a drill, milling cutter, or bore bar, or for use with a stationary tool such as a work-holding arbor or the like. The working end 4 of a rotary tool is driven in rotation about an axis of rotation 2 to perform cutting machining, torque transmission and the like. The shaft is designed to be inserted into, and precisely fixed in, a releasable supporting holder of a drive machine.

For this purpose the shaft is not cylindrical. It has a cross sectional circumference comprised of a series of arcs A1-A4. The curve A1 can optionally be flat. This segmented circumference extends along the portion of the shaft to be fixed in a holder. The arcs meet sequentially at their end points to form corners or edges E1-E4, two of which, E2 and E3, contact the bore 21 of the holder. A clamping element, such as a set screw 22 in the holder, presses against the midpoint of the first arc A1. This locks the shaft in and against the bore in a triangulated manner.

The simplicity of the multi-radial shaped shaft makes it very easy and inexpensive to produce. Each arc can be produced by cylindrical form grinding, in a process similar to that used to produce cams. The procedure to make a rotary cutting tool such as an end mill using the described multi-radial shape shaft is as follows:
1. Start with a rough tool blank (made by various means and of various materials) starting at a larger diameter than the final size.
2. The rough blank is gripped by the working end in a cylindrical form grinder and turned slowly. The multi-radial surface of the shaft is generated by varying the distance of a spinning grinding wheel from the center of rotation of the blank as it turns. This process is very similar to cam grinding. The arcs may be circular or non-circular.
3. The end of the blank with the multi-radial shape is then held in the spindle of a tool grinder gripped y a holding element similar to an end mill holder which the tool is intended to be used in, such as 20 in FIG. 5, allowing cutting flutes or other working features to be produced conventionally on the working end of the blank.

This is similar to the process to make a tool with a conventional cylindrical shaft. However, for a conventional cylindrical shaft, the grinding wheel does not vary in distance from the center of rotation of the blank as it turns. Instead, the entire rough blank is uniformly ground to a size slightly under nominal that allows it to slip into a holder bore. The multi-radial shaft form grinding process will cost slightly more than the cylindrical grinding process, but the benefits far outweigh any additional cost.

The following sequence of steps can be used to determine the location of the ridges and arcs forming the circumference of the present multi-radial shaft that permits its releasable insertion and clamping in fixed bore holders, and in non-fixed-bore holders also.

For this discussion, IDH is the exact diameter of the holder bore. Angles are centered on the centerline C0 of the shaft in a section plane normal to the centerline. Zero degrees is on the line from C0 through the midpoint of arc 1, or at 12 o'clock in the drawings. For example, the nine o'clock position in the drawings is 270 degrees.
a) Point E2 is located at a distance from C0 equal to 0.5 IDH and is angularly positioned between 115 and 150 degrees.
b) Point E1 is located at a distance from C0 approximately 0.3% less than that of E2, and is angularly positioned between 1 and 30 degrees.
c) A circular arc A2 is formed between E1 and E2 with a radius R2 of ½ IDH.
d) Arc A4 is formed symmetrically to A2 across the zero angle line through C0 and the midpoint of A1. Likewise points E3 and E4 are symmetrically located to points E2 and E1 respectively.
e) Arc A3 is formed between E2 and E3. Arc A3 lies inside the IDH circle centered on C0. The radius R3 of arc A3 is such that the widest gap between A3 and the IDH circle is approximately 0.18% of IDH.
f) Arc A1 is formed between E4 and E1. The radial center of A1 lies outside of the IDH circle in the 180 degree direction. Alternately, A1 can be replaced with a straight line.

One of the major benefits of the present shaft is that when it is gripped in a segmented collet chuck holder or a shrink fit holder, it runs nearly true (centered). Correctly centered and solidly gripped tools are not only more productive, but they last longer as well. An additional benefit of this shape is that when it is held in a segmented collet type holder or other non-end mill type holders it runs almost perfectly true. A shaft as described in Danielson would not run acceptably true in these other holders.

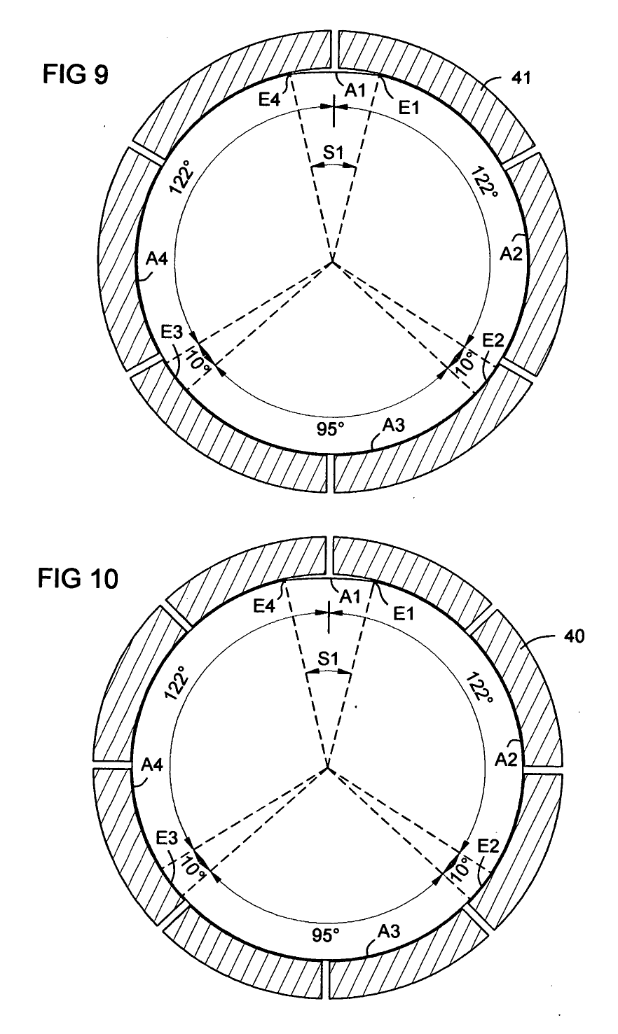

FIGS. 9 and 10 show how the present multi-radial shaft can be gripped effectively in multi-segmented collets in addition to other holders. The high and low points on the circumference of the shaft deviate so slightly from a circular form that they are easily accommodated by the individual collet sections

It is beneficial for a cutter to run as true as possible, but virtually all collet holders, including milling chucks, have some degree of eccentricity. Some collet chuck makers claim that tools run true to within two ten thousandths of an inch in their holders, but most of them are actually less true than that, and there is little that can be done to correct the eccentricity when using a tool with a cylindrical shaft. Tapping or hammering the tool into alignment is sometimes attempted, but under load the tool can creep back to the original eccentric position.

When a multi-radial shaft according to the present invention is held in a rare, perfectly true-running collet holder, the tool will run very slightly eccentric, but to a generally acceptable degree. However, in the usual case with a slightly eccentric running collet holder, the eccentricity in the holder can be at least partially corrected by rotating the multi-radial shaft in the holder to a position where the eccentricities of the holder and shaft offset each other, thus improving the centricity of the tool. This adjustment cannot be done with cylindrical shafts or the shaft of Danielson.

Although the present invention has been described herein with respect to preferred embodiments, it will be understood that the foregoing description is intended to be illustrative, not restrictive. Modifications of the present invention will occur to those skilled in the art. All such modifications that fall within the scope of the appended claims are intended to be within the scope and spirit of the present invention.

I claim:

1. A shaft for use in combination with a shaft holder having a generally cylindrical bore with an axis and a radius, the shaft comprising:
a working end having a centerline;
an insertion length of the shaft comprising a length of the shaft to be inserted in the bore;
a circumference on a section plane normal to the centerline along the insertion length of the shaft;
the circumference comprising a series of arcs in a sequence, including a first arc having a midpoint, each arc meeting the next arc in the sequence at a common endpoint of the two arcs;
each common endpoint forming a slight ridge along the insertion length of the shaft;
a clamping pressure point on the circumference at approximately the midpoint of the first arc;
an opposite point on the circumference that is opposite the pressure point on a line from the pressure point through the centerline;
a first two of the ridges flanking the pressure point and having a distance from the centerline that is less than the radius of the bore; and
a second two of the ridges flanking the opposite point and having a distance from the centerline equal to the radius of the bore;
whereby when the shaft is inserted into the bore and clamped in the holder, the first two of the ridges provide clearance, and the second two of the ridges contact the bore, causing the centerline of the shaft to be precisely coincident with the axis of the holder.

2. The shaft of claim 1 wherein the first arc is replaced with a flat line.

3. The shaft of claim 1 wherein:
the first arc is a substantially circular arc with a center point;
the first arc has a different center point from the other arcs and from the shaft centerline;
the center point of the first arc lies outside the circumference on the opposite side of the circumference from the first arc.

4. The shaft of claim 1 wherein the holder bore has an exact diameter IDH, the transverse sectional shape of the shaft is designed in a section plane normal to the centerline C0, with angles centered on the centerline, zero degrees being on the line from C0 through the midpoint of an arc A1 as defined below, an IDH circle is defined as a circle with diameter IDH centered on C0, and the shaft is designed using substantially the following steps:
a) locating a point E2 at a distance from C0 equal to 0.5 IDH and angularly positioned between 115 and 150 degrees;
b) locating a point E1 at a distance from C0 approximately 0.3% less than that of E2, and angularly positioned between 1 and 30 degrees;
c) forming a circular arc A2 between E1 and E2 with a radius R2 of approximately 0.5 IDH;
d) forming an arc A4 symmetrically to arc A2 across the line through C0 and the midpoint of A1;
e) locating a point E3 symmetrically to E2 across the line through C0 and the midpoint of A1;
f) locating a point E4 symmetrically to E1 across the line through C0 and the midpoint of A1;
g) forming a generally circular arc A3 between points E2 and E3 that lies inside the IDH circle, the radius R3 of arc A3 being such that the widest gap between A3 and the IDH circle is approximately 0.18% of IDH; and
h) forming a generally circular arc A1 between points E4 and E1 with a radial center that lies outside the IDH circle in the 180-degree direction.

5. The shaft of claim 4 wherein arc A1 is replaced with a flat line.

6. A shaft for use in combination with a shaft holder having a generally cylindrical bore with an axis, a radius, and a clamping element, the shaft comprising:
a working end having a centerline;
an insertion length of the shaft comprising a length of the shaft to be inserted in the bore;
a circumference on a section plane normal to the centerline along the insertion length of the shaft;
the circumference comprising first, second, third, and fourth arcs meeting end-to-end respectively in sequence in a closed loop;
each common endpoint between the arcs forming a slight ridge along the insertion length of the shaft, resulting in first, second, third, and fourth ridges;
the first arc having two endpoints at the first and fourth ridges;
the first and fourth ridges lying at a distance from the centerline that is less than the radius of the bore;
the second and third ridges lying at a distance from the centerline that is equal to the radus of the bore;
whereby when the shaft is inserted into the bore and clamped in the holder by a clamping element that exerts radially inward force on substantially the midpoint of the first arc, the first and second ridges provide clearance, while the second and third ridges contact the bore, causing the centerline of the shaft to be precisely coincident with the axis of the holder.

7. The shaft of claim 4 wherein the first arc is replaced with a flat line.

8. The shaft of claim 4 wherein:
the first arc is a substantially circular arc with a center point;
the first arc has a different center point from the other arcs and from the shaft centerline;
the center point of the first arc lies outside the circumference on the opposite side of the circumference from the first arc.
